(19) United States
(12) Patent Application Publication
(10) Pub. No.: US 2017/0066084 A1
(43) Pub. Date: Mar. 9, 2017

(54) THERMOGRAPHY FOR QUALITY ASSURANCE IN AN ADDITIVE MANUFACTURING PROCESS

(71) Applicant: MTU Aero Engines AG, Munich (DE)

(72) Inventors: Alexander Ladewig, Bad Wiessee (DE); Georg Schlick, Munich (DE); Gunter Zenzinger, Waakirchen (DE); Joachim Bamberg, Dachau (DE); Thomas Hess, Munich (DE)

(21) Appl. No.: 15/308,938

(22) PCT Filed: Apr. 24, 2015
(86) PCT No.: PCT/DE2015/200278

§ 371 Date: Nov. 4, 2016

(30) Foreign Application Priority Data
May 9, 2014 (DE) 10 2014 208 768.6

(51) Int. Cl. B23K 26/342; G01N 25/72; B33Y 40/00; B33Y 50/02; B23K 26/03; G01J 5/10; B33Y 10/00

(52) U.S. Cl. CPC B23K 26/342; G01J 5/10; G01N 25/72; B33Y 10/00; B33Y 50/02; B23K 26/034; B33Y 40/00; G01J 2005/0081

(57) ABSTRACT

The invention relates to a method and a device for the quality assurance of at least one component (14) during its production, wherein production is achieved by means of an additive manufacturing method with at least one processing laser (22), said method comprising the following steps: —layered assembly of the component (14), —thermographic recording of a plurality of images, over a defined period, of at least one component region (17) in the laser beam by means of at least one recording sensor (18), —detecting a temporal change in the heat distribution in a molten-pool-free component region, wherein the occurrence of a defect, (e.g. a crack, foreign material, a pore, a bonding fault or similar) in the uppermost component layer or beneath same is detected on the basis of a characteristic temporal change in the heat distribution at the defect (30).

The invention relates to a method for the quality assurance of at least one component during the production thereof according to the preamble of patent claim 1 and a device for carrying out the method according to the preamble of patent claim 11.

Laser thermography methods that are used as nondestructive test methods (NDT methods) for the detection of cracks in components are known from the prior art. In this connection, the cooling of the surface of the component being tested is detected with a laser thermography camera. These methods are associated with limitations, however, since the component being tested must be encased or enclosed for safety reasons with laser technology. Due to the high energy of the laser, there occurs a considerable heating of the surface of the component being tested. In the case of an additive manufacturing method, the production process must be interrupted for the testing or inspection of the component. A second energy source is necessary for heating the component.

Therefore, the object of the invention is to provide a method that makes possible a nondestructive test or inspection of a metal component during the production process (inspection by means of an online method) for defects such as cracks, foreign materials, pores, bonding defects, and the like, in the case of an additive manufacturing method.

The object is achieved according to the invention by a method according to patent claim 1. In addition, the object is achieved with a device according to patent claim 11. Advantageous embodiments of the invention are contained in the dependent claims.

According to the invention, the object is achieved by a method for the quality assurance of at least one component during the manufacture thereof, wherein the production is carried out by means of at least one additive manufacturing method with at least one processing laser, the method comprising the following steps:
building up the component layer by layer;
thermographic recording of at least one image from at least one component region in the laser beam by means of at least one recording sensor.

A recording of a plurality of images that detect a temporal change in a heat distribution in a molten-pool-free component region is then produced in a defined time span, wherein, when at least one defect occurs, such as a crack, foreign material, a pore, a bonding defect, and the like, in the uppermost component layer or thereunder, the component region has a characteristic temporal change in a heat distribution at the defect, wherein the temporal profile of the heat distribution and thus the defect will be made visible by means of the associated recording of the plurality of images.

A characteristic heat distribution at the defect is understood to be a temporal change in a heat distribution that arises at the defect specifically due to a discontinuity in the material at the defect. By the method according to the invention, it is possible each time during the additive manufacture, to inspect the last layer of a component produced and several layers lying thereunder during the manufacture. In this way, an inspection is carried out in the form of an online method, by means of which the entire component can be investigated and documented for defects continuously during the build-up or production. Preferably, images are recorded for each individual layer. With the method according to the invention, it is thus possible to conduct an inspection of defects such as cracks, foreign material, spores, bonding defects, and the like, by means of an online method without significant additional expense. Inner defects can be detected nondestructively, so that the component can be approved for aviation without subsequent downstream inspections.

In a specific embodiment of the invention, the thermographic recording detects the heat distribution due to the laser beam by means of a recording sensor, in particular a photodiode array and an optical scanning unit. In this way, the size of the recording sensor can be clearly smaller than the size of recording sensors of thermographic units according to the prior art, since the recording region of the recording sensor is continually diverted to the component region being investigated instantaneously by means of the optical scanning unit, and not to the entire component layer. In addition, with a recording through the laser beam, the recorded component region can lie closer to the laser beam.

In another specific embodiment of the invention, the thermographic recording of images is carried out after the building up of a component layer, wherein the processing laser sweeps over the built-up component layer, line by line, and thus the surface temperature of the component increases just slightly so that any influencing of the heat distribution in the component layer will be avoided. An examination of a component layer that is complete will be made possible in this way.

In particular, the recording sensor will be selected as small as possible, so that a defined component region that lies behind an incident surface of the laser beam, with respect to the direction of movement of the laser beam, will still be directly detected. A recording sensor that is as small as possible makes possible a high resolution and a high recording speed, and thus a high precision in the recording of images.

In an alternative embodiment of the invention, the thermographic recording of the images is carried out during the building up of a component layer, wherein the processing laser produces a local molten pool. The component layer can still be investigated in this way during its build-up.

The recording sensor will be selected appropriately as small as possible, so that a defined component region that lies behind the molten pool, with respect to the direction of movement of the laser beam, and is hardened directly or is already hardened, will still be detected directly. For example, a photodiode array that is as small as possible makes possible a high resolution and a high recording speed, and thus a high precision in the recording of images.

In another specific design, at least some of the applied layers are subjected to a controlled heat treatment below the melting point of the material of the component prior to the thermographic recording of the associated images, wherein the heat treatment induces the last layer applied to radiate heat, particularly in the infrared region at the edge of the visible spectrum and within the detection spectrum of the recording sensor, which, when at least one defect, such as a crack, foreign material, a pore, a bonding defect, and the like, occurs in the layer, has a characteristic temporal heat distribution at the defect, wherein this heat distribution and thus the defect will be made visible by means of the associated thermographic recording of the plurality of images.

Thus, a reduced heat input will be carried out, which raises the temperature in the layer locally to a level at which radiated heat will be emitted in the near infrared without thereby producing re-melting. The radiated heat in this case, however, occurs so near the edge of the visible spectrum that a high-resolution recording sensor can detect the heat distribution.

In addition, the additive manufacturing method can be a selective laser melting and/or a selective laser sintering. These methods are particularly well suitable for the additive manufacture of metal components.

In an advantageous enhancement of the invention, the defect will be corrected by re-melting of the site affected by the defect or of the component layer. Not only will the quality of the layer be inspected in this way, but it will also be assured.

Specifically, the images recorded by the thermographic unit can be analyzed, and if a defect is detected, a signaling unit can be activated and/or a re-melting of the site affected by the defect or a re-melting of the component layer can be triggered. These method steps can be carried out purely manually, fully automatically, or partially automatically or partially manually. Activation of the signaling unit can alert an operator when a defect is detected. The operator can then interrupt the additive manufacture of the component and adjust the processing laser for the additive manufacturing method so that the site affected by the defect or the component layer will be re-melted. Alternatively, the re-melting of the site affected by the defect or the re-melting of the component layer can be triggered automatically. In this case, an alarm signal can be additionally produced.

In addition, the object is achieved by a device for the quality assurance of at least one component during the manufacture thereof, wherein the production is carried out by means of at least one additive manufacturing method with at least one additive manufacturing unit that comprises at least one processing laser, and at least one thermographic unit having at least one recording sensor. The thermographic unit also comprises at least one optical scanning unit, wherein the recording sensor has a recording speed matched to that of the optical scanning unit, by means of which a plurality of images can be recorded in a defined time span, and thus a temporal change in a heat distribution can be shown in a defined molten-pool-free component region. In this way, the size of the recording sensor can be clearly smaller than the size of recording sensors of thermographic units according to the prior art, since, according to the invention, the recording region of the recording sensor is continually diverted to the component region being investigated instantaneously by means of the optical scanning unit, and not to the entire component layer.

In a specific enhancement, the recording sensor comprises a photodiode array that has dimensions that are as small as possible. Small dimensions make possible high recording speeds.

In another specific embodiment, the recording speed of the recording sensors is at least 1000 fps. High scanning rates and high recording speeds make possible a high precision in image recording.

Also, the processing laser of the additive manufacturing unit can simultaneously be the energy source for the controlled heat treatment. For example, the processing laser already present in the additive manufacturing unit can be used for the heat treatment, so that another energy source is not necessary.

Advantageously, the device comprises at least one display unit, at least one evaluating unit, at least one signaling unit for reporting a defect, such as a crack, foreign material, a pore, a bonding defect, and the like, and at least one control of the processing laser of the additive manufacturing unit.

The recordings detected by the recording sensor can be optically shown on the display unit. The evaluating unit serves for data processing. The signaling unit can alert an operator when a defect is detected. The operator can then interrupt the additive manufacture of the component and control the processing laser for the additive manufacturing method, so that the site affected by the defect or the component layer will be re-melted. Alternatively, the re-melting of the site affected by the defect or component layer can be automatically triggered from the evaluating unit by means of the control of the processing laser for the additive manufacturing method. In this case, the signaling unit can be additionally activated.

Exemplary embodiments of the invention will be explained below in more detail on the basis of five greatly simplified figures. Herein:

FIG. 1 shows a perspective view of an excerpt from a device according to the invention;

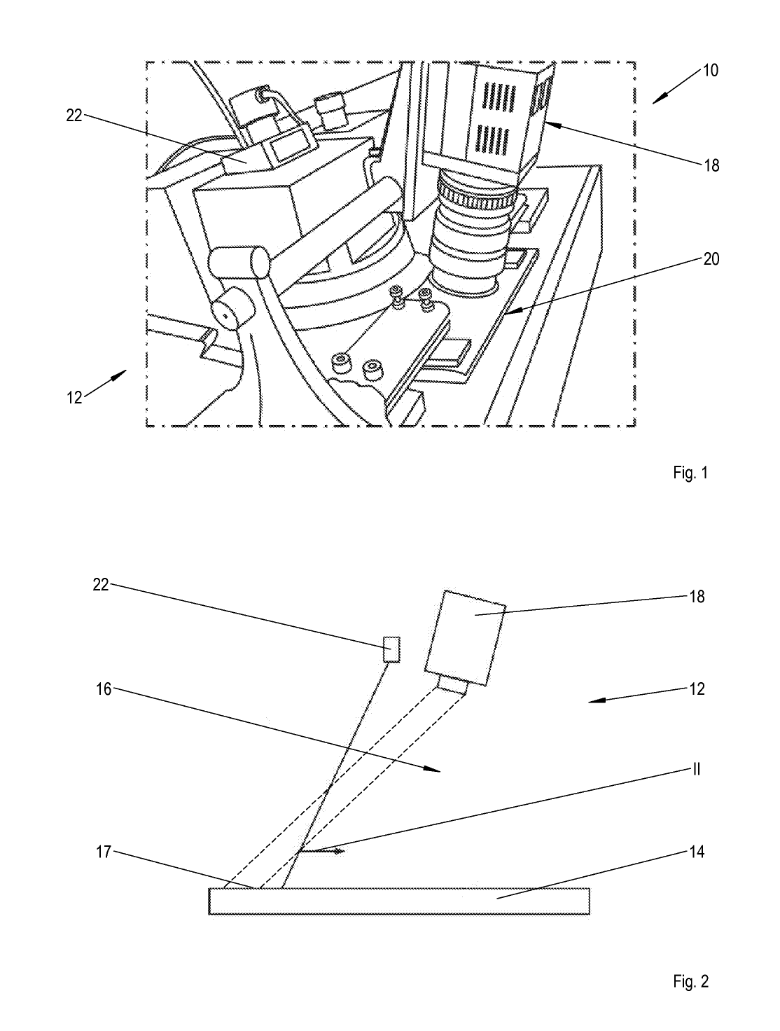

FIG. 2 shows a schematic lateral view of the device according to the invention according to FIG. 1;

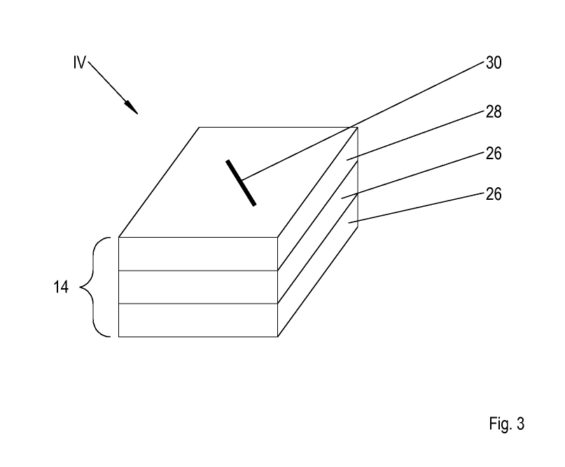

FIG. 3 shows a perspective enlargement of an excerpt from a component region; and

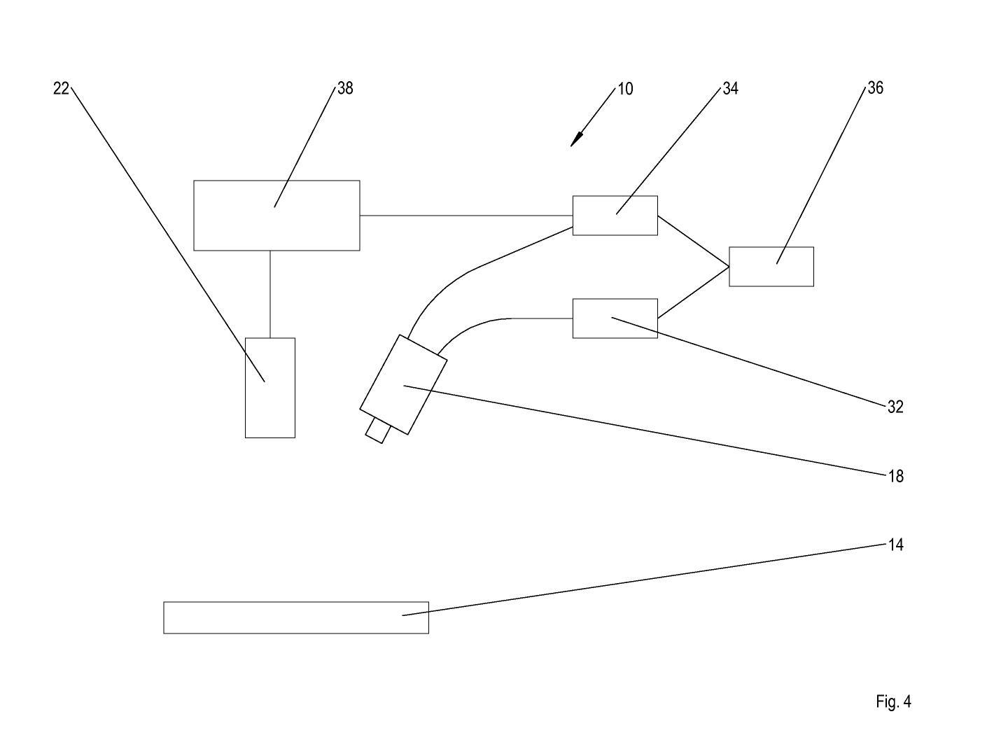

FIG. 4 shows a sketch of the principle of the device according to the invention.

FIG. 1 shows a perspective view of an excerpt of a device 10 according to the invention, which comprises an additive manufacturing unit 12 for producing a component 14. FIG. 1 will be explained in the following in conjunction with FIG. 2, in which a schematic lateral view of the device 10 according to the invention according to FIG. 1 is illustrated. The device 10 serves for carrying out a method for the quality assurance of a component 14 during the production thereof.

The additive manufacturing unit 12 itself is presently designed as a selective laser melting (SLM) system, which is known in and of itself, i.e., a laser or a processing laser 22 is the energy source for the melting process. The laser is directed downward, so that the component 14 can be produced from bottom to top in layers introduced on top of one another.

A thermographic unit 18 is arranged above a build-up space 16 (FIG. 2) of the additive manufacturing unit 12 and serves for the purpose of detecting a temporal change in the heat profile in the uppermost layer of component 14 during the production thereof. The thermographic unit 18 is directed each time onto the uppermost layer of component 14, wherein the detection angle of the thermographic unit 18 only covers the component region 17. The thermographic unit is disposed in a vertical plane that corresponds here to the image plane in FIG. 2, between the laser 22 and the outer limits of the build-up space 16. In this way, an optical distortion will be avoided, which otherwise might occur with a thermographic unit 18 that is inclined too steeply. In addition, the thermographic unit 18 can record images through the laser beam on the basis of this arrangement.

A laser protection glass 20 (FIG. 1) is disposed between the build-up space 16 (FIG. 2) and the thermographic unit 18, in order to prevent damaging a recording sensor and/or a photodiode array of the thermographic unit 18, such as, e.g., a camera, by laser 22 of the additive manufacturing unit 12. The thermographic unit 18 is thus found above the build-up space 16 and outside the beam path II of the laser 22 of the additive manufacturing unit 12. In this way, it is assured that the thermographic unit 18 is not found in the beam path II and that the laser 22 correspondingly does not suffer any energy losses due to optical elements such as semitransparent mirrors, grids, or the like. In addition, the thermographic unit 18 does not influence the production process of component 14 and can also be easily exchanged or retrofitted.

The thermographic unit 18 presently comprises an IR-sensitive photodiode array with a recording speed of preferably at least 1000 fps. Although basically other types of sensors, black-and-white cameras or the like can also be used, a color sensor or a sensor having a broad spectral range supplies comparatively more information, which permits a correspondingly more accurate evaluation of the component region 17.

In order to produce component 14, in a way known in and of itself, thin powder layers of a high-temperature-resistant metal alloy are introduced onto a platform (not shown) of the additive manufacturing unit 12, locally melted by means of the laser 22, and solidified by cooling. Subsequently, the platform is lowered, another powder layer is introduced and again solidified. This cycle is repeated until component 14 is produced. An exemplary component 14 is composed of up to 2000 component layers and has a total layer height of 40 mm. The finished component 14 can be further processed subsequently or can be used immediately.

In the case of the method according to the invention, the uppermost layer of component 14 can be subjected each time to a heat treatment below the melting point of the material of the component. This heat treatment causes the uppermost layer to radiate heat, and this radiated heat can be detected by means of a thermographic unit 18. The radiated heat of the uppermost layer is adjusted so that it lies in the infrared region at the edge of the visible spectrum and also within the sensitivity region of the thermographic unit 18. Preferably, each layer applied is subjected to a heat treatment.

In an alternative example of embodiment, a subsequent heat treatment is omitted. Instead of this, for the inspection of defects, the component region 17 is recorded behind a molten pool, with respect to the direction of movement of the laser (II in FIG. 2).

The temporal change in the heat profile in the uppermost layer of component region 17 in this case is determined in the form of an image sequence by means of the thermographic unit 18. The temporal change in the heat profile in the uppermost layer of component 14 and, if needed, additional information derived therefrom, such as, e.g., the locating of defects in the uppermost layer or thereunder, are subsequently spatially resolved, and, for example, coded via brightness values and/or colors by means of a display unit 32 (FIG. 4).

During the testing or inspection of component 14, the latter is arranged without encasing or enclosure in the additive manufacturing unit 12. An encasing or enclosure is not necessary, since the thermographic unit 18 does not have any effect on the heat profile in component 14 either during the additive manufacture or during the inspection of component 14.

Not only is geometric information obtained by optical thermography, but information is also obtained on the local temperature distribution and the temporal change in the heat profile in the component region 17 in question. Basically, it can be provided that the distance traveled by the laser beam per individual image amounts to between 10 mm and 120 mm, thus for example, 10 mm, 20 mm, 30 mm, 40 mm, 50 mm, 60 mm, 70 mm, 80 mm, 90 mm, 100 mm, 110 mm or 120 mm. In addition, it can be basically provided that each image sequence or plurality of images will be determined within 2 minutes, in order to avoid a cooling of the component layers that is too intense, and thus to avoid a concomitant loss of information.

The component 14 may have a defect that may be, for example, a crack, in its uppermost layer. Other possible defects are pores, foreign materials, bonding defects, and the like. The crack can be a hot crack or a segmentation crack.

FIG. 3 shows an enlargement of an excerpt from the component region 17. As an example, three layers 26, 28 of component 14 are shown here. However, component 14 may also comprise more or fewer layers 26, depending on the instantaneous state of manufacture. The two layers 26 shown here are defect-free layers or crack-free layers, whose absence of cracks could be established by means of the thermographic unit 18, so that the manufacturing process was conducted further. The uppermost layer of component 14 is a layer 28 affected by a crack.

The profile and the form of crack 30 are only shown schematically here. More than one crack 30 may also occur in layer 28. The crack can assume any form whatever. The length and the width of crack 30 can vary and lie in the range of a few micrometers. These small dimensions can only be detected by means of the thermographic unit 18. Cracks 30 of this order of magnitude can also only be detected by the corresponding above-described recording of the image sequence or plurality of images for depicting the temporal change in the heat distribution. Cracks or defects can also be determined in several layers underneath the uppermost layer 28. That is, if there are defects in or underneath the uppermost layer 28, the temporal change in the heat distribution is disrupted.

If the length and/or the maximum width of the crack 30 is (are) less than specific limit values, the additive manufacture can be continued. If the limit values, however, are reached or exceeded, the production process for the corresponding component 14 is terminated prematurely or the layer 28 of component 14 affected by the crack is corrected by a re-melting.

According to FIG. 4, each component region is detected optically in the same way as component region 17 by means of the thermographic unit 18 and depicted on display unit 32. Also, the thermographic unit works in conjunction with at least one evaluating unit 34, so that the recorded images are classified and stored therein, and optionally, an order can be triggered to interrupt the additive manufacturing process of the crack-affected component 14. The evaluating unit 34 is configured so that it can recognize the crack 30 in the uppermost layer 28 of component 14 by means of an algorithm. These procedures, however, may also be conducted manually by an operator after evaluation of the images or recordings of the thermographic unit 18 on the display unit 32.

If, by means of the thermographic unit 18 and the evaluating unit 34, it is recognized that the component region 17 is affected by a defect, and here a crack, the additive manufacturing process can be interrupted and the crack-affected site or the entire layer 28 can be corrected by re-melting. The re-melting of the crack-affected layer 28 is carried out, for example, as follows: upon automatic detection of a crack 30, the evaluating unit 34 provides a corresponding order to the control 38 of laser 22 to interrupt the additive manufacturing process and provide re-melting.

Alternatively, the additive manufacturing process can be terminated prematurely for a crack-affected component 14. This is conducted by a manually triggered order or an order that is triggered automatically from the evaluating unit 34 to the control 38 of laser 22.

The premature termination of the additive manufacturing process will preferably be carried out when component 14 has only a small number of layers 26, 28. When component 14 is almost finished, an interruption and a re-melting of the site affected by the defect or layer 28 is preferred.

Very generally, the evaluating unit 34 can also trigger an alarm by means of a signaling unit 36, in the form of acoustic or optical signals, e.g., in the form of a warning message on the display unit 32 or another computing unit (not shown) connected to the additive manufacturing unit 12. Then an operator can decide whether and how the additive manufacture of components 14 will be continued.

The evaluating unit 34 and the signaling unit 36, including the necessary signal lines between the thermographic unit 18, the evaluating unit, the signaling unit 36, and the control 38 of laser 22 of additive manufacturing unit 12, are components of device 10.

The recording sensor or the photodiode array of the thermographic unit records images through the beam path of laser 22 and measures the temporal change in the heat distribution. The recording sensor used in this case is of small size, since the field of vision of the recording sensor is continually deflected onto the position currently being investigated by the scanning optics. As a consequence of this, the recording speed can be at least 1000 fps. In this way, a high measurement precision can be achieved.

The invention also relates to a method for the quality assurance of at least one component (14) during its production, wherein the production is carried out by means of at least one additive manufacturing method with at least one processing laser, which comprises the following steps:
building up the component (14) layer by layer;
thermographic recording of at least one image from at least one component region in the laser beam by means of at least one recording sensor,

the method being characterized in that a recording of a plurality of images that detect a temporal change in a heat distribution in a molten-pool-free component region is produced in a defined time span, wherein, when at least one defect (30) occurs, such as a crack (30), foreign material, a pore, a bonding defect, and the like, in the uppermost component layer or thereunder, the component region has a characteristic temporal change in a heat distribution at the defect (30), wherein the temporal profile of the heat distribution and thus the defect (30) will be made visible by means of the associated recording of the plurality of images.

The invention also relates to a method for the quality assurance of at least one component during its production, wherein the production is carried out by means of at least one additive manufacturing method with at least one processing laser, which comprises the following steps:
building up the component layer by layer;
thermographic recording of at least one image from at least one component region in the laser beam by means of at least one recording sensor.

In order to make possible a nondestructive testing or inspection of a metal component during the production process (inspection by means of an online method) for defects such as cracks, foreign materials, pores, bonding defects, and the like, a recording of a plurality of images that detect a temporal change in a heat distribution in a molten-pool-free component region is produced in a defined time span, wherein, when at least one defect occurs, such as a crack, foreign material, a pore, a bonding defect, and the like, in the uppermost component layer or thereunder, the component region has a characteristic temporal change in a heat distribution at the defect, wherein the temporal profile of the heat distribution and thus the defect will be made visible by means of the associated recording of the plurality of images.

### LIST OF REFERENCE SYMBOLS

10 Device
12 Additive manufacturing unit
14 Component
16 Build-up space
17 Component region
18 Thermographic unit
20 Laser protection glass
22 Laser
26 Crack-free layer
28 Crack-affected layer
30 Crack
32 Display unit
34 Evaluating unit
36 Signaling unit
38 Control
II Beam path of the laser

1. A method for the quality assurance of at least one component (14) during the production thereof, wherein the production is carried out by at least one additive manufacturing method with at least one processing laser, the method comprising the following steps:
building up the component (14) layer by layer;
thermographic recording of at least one image from at least one component region (17) in the laser beam by means of at least one recording sensor,
wherein a recording of a plurality of images that detect a temporal change in a heat distribution in a molten-pool-free component region (17) is produced in a defined time span, wherein, when at least one defect (30) occurs, such as a crack (30), foreign material, a pore, a bonding defect, and the like, in the uppermost component layer or thereunder, the component region (17) has a characteristic temporal change in a heat distribution at the defect (30), wherein the temporal profile of the heat distribution and thus the defect (30) will be made visible by means of the associated recording of the plurality of images.

2. The method according to claim 1, wherein the thermographic recording detects the heat distribution through the laser beam by the recording sensor, including a photodiode array and an optical scanning device.

3. The method according to claim 1, wherein the thermographic recording of the images is carried out after the building up of a component layer (26, 28), wherein the processing laser sweeps over the built-up component layer, line by line, and thus the surface temperature of component (14) increases just slightly so that any influencing of the heat distribution of component layer (26, 28) will be avoided.

4. The method according to claim 3, wherein the recording sensor is selected as small as possible, so that a defined component region (17) that lies behind an incident surface of the laser beam, with respect to the direction of movement of the laser beam, will still be directly detected.

5. The method according to claim 1, wherein the thermographic recording of the images is carried out during the building up of a component layer (26, 28), wherein the processing laser (22) produces a local molten pool.

6. The method according to claim 5, wherein the recording sensor is selected as small as possible, so that a defined component region (17) that lies behind the molten pool, with respect to the direction of movement of the laser beam, and is hardened directly or is already hardened, will still be directly detected.

7. The method according to claim 3, wherein at least some of the applied layers (26, 28) are subjected to a controlled heat treatment below the melting point of the material of the component prior to the thermographic recording of the associated images, wherein the heat treatment induces the last layer applied to radiate heat, and when at least one defect (30) occurs in the layer (28), such as a crack (30), foreign material, a pore, a bonding defect, the radiated heat has a characteristic temporal heat distribution at the defect (30), wherein this heat distribution and thus the defect (30) will be made visible by the associated recording of the plurality of images.

8. The method according to claim 1, wherein the additive manufacturing method is a selective laser melting and/or a selective laser sintering.

9. The method according to claim 1, wherein the defect (30) is corrected by a re-melting of the site affected by the defect or a re-melting of component layer (28).

10. The method according to claim 1, wherein the images recorded by the thermographic unit (18) are analyzed, and if a defect (30) is detected, a signaling unit is activated and/or a re-melting of the site affected by the defect or component layer (28) will be triggered.

11. A device (10) for the quality assurance of at least one component during the production thereof, comprising at least one processing laser, and at least one thermographic unit (18) having at least one recording sensor, wherein the thermographic unit also comprises at least one optical scanning unit, wherein the recording sensor has a recording speed matched to that of the optical scanning unit, by means of which a plurality of images can be recorded in a defined time span, and thus a temporal change in a heat distribution can be shown in a defined molten-pool-free component region.

12. The device according to claim 11, wherein the recording sensor comprises a photodiode array, which has dimensions that are as small as possible.

13. The device according to claim 11, wherein the recording speed of the recording sensor is at least 1000 fps.

14. The device according to claim 11, wherein the processing laser (22) of the additive manufacturing unit (12) is simultaneously the energy source for the controlled heat treatment.

15. The device according to claim 11, wherein the device (10) comprises at least one display unit (32), at least one evaluating unit (34), at least one signaling unit (36) for reporting a defect (30), such as a crack, foreign material, a pore, a bonding defect, and the like, and at least one control (38) of the processing laser (22) of the additive manufacturing unit (12).
